(19) United States
(12) Patent Application Publication
(10) Pub. No.: US 2013/0056291 A1
(43) Pub. Date: Mar. 7, 2013

(54) FUEL CELL SYSTEM FOR VEHICLE AND FUEL CELL VEHICLE

(71) Applicant: Yutaka Hotta, Toyota-shi (JP)

(72) Inventor: Yutaka Hotta, Toyota-shi (JP)

(73) Assignee: TOYOTA JIDOSHA KABUSHIKI KAISHA, Toyota-shi (JP)

(21) Appl. No.: 13/697,472

(22) PCT Filed: May 13, 2010
(86) PCT No.: PCT/JP2010/058118

§ 371 Date: Nov. 12, 2012

(51) Int. Cl. H01M 8/24; B60L 11/18; B60K 1/00

(52) U.S. Cl. 180/65.31; 429/456

(57) ABSTRACT

A fuel cell system for a vehicle is provided which can be efficiently arranged under the vehicle floor. The fuel cell system for a vehicle according to the invention comprises, under the vehicle floor: a fuel cell which is supplied with an oxidant gas and a fuel gas and which generates electric power through an electrochemical reaction; an auxiliary device related to the operation of the fuel cell; and a converter that converts electric power generated by the fuel cell, wherein the fuel cell, the auxiliary device and the converter are arranged serially in a front-back direction of the vehicle and the auxiliary device is arranged so as to be adjacent to the fuel cell.

### TECHNICAL FIELD

The present invention relates to a fuel cell system for a vehicle, having a fuel cell, and also relates to a fuel cell vehicle.

### BACKGROUND ART

Fuel cell systems which use, as an energy source, fuel cells that generate electric power through electrochemical reaction of reactant gases (oxidant gas and fuel gas) have drawn attention in recent years. Some vehicles have such fuel cell system mounted under the floor of the vehicle.

Examples of the technique for mounting such system under the floor of the vehicle include: a configuration of arranging a fuel cell, a converter and auxiliary devices under the floor such that the converter is placed on the left or right of the fuel cell (see, for example, Patent Document 1); a configuration of arranging a fuel cell , auxiliary devices and a converter circuit under the floor of the vehicle and simplifying electrical wiring (see, for example, Patent Document 2); and a configuration of arranging a boost converter and a fuel cell on the floor of the vehicle (see, for example, Patent Document 3).

Examples also include: a configuration of arranging a fuel cell and auxiliary devices in a space at the front of the vehicle so as have stable balance in terms of the center of gravity (see, for example, Patent Document 4); a configuration of arranging auxiliary devices, a fuel cell and a power converter under the floor of the vehicle, in this order, so as obtain improved layout properties (see, in particular, Patent Document 5); and a configuration of arranging auxiliary devices, a fuel cell and a power conversion regulator under the floor of the vehicle, in this order, so as to shorten the pipes (see, in particular, Patent Document 6).

### PRIOR ART REFERENCES

### Patent Documents

Patent Document 1: JP2007-015616 A

Patent Document 2: JP2009-113623 A (pages 2, 4, 6, FIG. 1)

Patent Document 3: JP2010-004666 A (pages 2, 6, 8, FIG. 2)

Patent Document 4: JP2005-306207 A (pages 2, 4, 5, FIGS. 2, 5)

Patent Document 5: JP2006-076485 A (pages 2, 3, FIG. 1)

Patent Document 6: JP2006-113623 A (pages 2-4, FIG. 1)

### SUMMARY OF THE INVENTION

### Problem to be Solved by the Invention

In order to ensure a sufficient amount of space in the interior of the vehicle, the space under the floor of the vehicle will be limited in the vehicle-width direction and in the height direction.

Accordingly, when mounting a fuel cell, auxiliary devices and a converter which constitute the fuel cell system (hereinafter, they will sometimes collectively be referred to as “system components”) under the floor of the vehicle, it is necessary to arrange them efficiently in the limited space under the floor by taking into account not only the system components themselves but also the routing of the pipes and the wiring connecting such system components (easier processes of wiring, simplification of wiring, etc.).

The invention has been made in view of the above-described circumstances and an object of the invention is to allow a fuel cell system for a vehicle to be efficiently arranged under such vehicle's floor.

### Means for Solving the Problem

In order to achieve the above object, the invention provides a fuel cell system for a vehicle, comprising, under a floor of the vehicle: a fuel cell which is supplied with an oxidant gas and a fuel gas and which generates electric power through an electrochemical reaction; an auxiliary device related to the operation of the fuel cell; and a converter that converts electric power generated by the fuel cell, wherein the fuel cell, the auxiliary device and the converter are arranged serially in a front-back direction of the vehicle and the auxiliary device is arranged so as to be adjacent to the fuel cell.

In the vehicle fuel cell system of this configuration, the fuel cell to be arranged under the floor of the vehicle, the converter, also to be arranged under the floor, and the auxiliary device for the fuel cell, also to be arranged under the floor, are serially arranged in the front-back direction of the vehicle. In this arrangement, although the connection relationship (hereinafter, sometimes referred to simply as “routing”) of the pipes and wiring between the converter, the auxiliary device and the fuel cell includes some crossing portions only in the wiring between the fuel cell and the converter, the other portions are not redundant and the routing is thus favorable.

Accordingly, the converter, the auxiliary device and the fuel cell, as well as the pipes and wiring connected thereto, can be efficiently arranged in the space under the floor of the vehicle which is narrow in the vehicle-width direction and in the vertical direction.

Further, in the vehicle fuel cell system according to the invention, if the fuel cell is formed by stacking a predetermined number of unit cells, each being supplied with the oxidant gas and the fuel gas and generating electric power through the electrochemical reaction, and if the oxidant gas and the fuel gas are supplied and discharged at one end of the fuel cell in the cell stacking direction, the converter, the auxiliary device and the fuel cell may be serially arranged in this order from the front in the front-back direction of the vehicle.

Further, in the vehicle fuel cell system according to the invention, if the fuel cell is formed by stacking a predetermined number of unit cells, each being supplied with the oxidant gas and the fuel gas and generating electric power through the electrochemical reaction, and if the oxidant gas is supplied and discharged at one end of the fuel cell in the cell stacking direction and the fuel gas is supplied and discharged at the other end of the fuel cell in the cell stacking direction, the converter, the fuel cell and the auxiliary device may be serially arranged in this order from the front in the front-back direction of the vehicle.

The above-described auxiliary device includes a device related to the supply and discharge of fluid to and from the fuel cell and a pipe and/or wiring connected to the device. The supply and discharge of fluid to and from the fuel cell includes, for example, supply and discharge of the oxidant gas, the fuel gas, and a coolant provided to cool the fuel cell and the converter.

A fuel cell vehicle according to the invention is a fuel cell vehicle having any of the above-described vehicle fuel cell systems mounted therein, wherein: a controller that controls the converter, the auxiliary device and the fuel cell; a radiator for cooling the fuel cell and the converter; a traction motor for driving the vehicle, which is electrically connected to the converter; and an air compressor that compresses air, as the oxidant gas, and sends the air to the fuel cell, are arranged in a compartment formed at the front of the vehicle, and wherein the converter, the auxiliary device and the fuel cell are arranged at the back of the compartment, in an underfloor space formed under an interior of the vehicle.

### Effect of the Invention

According to the invention, a fuel cell, an auxiliary device and a converter, including pipes and wiring connected thereto, can be efficiently arranged under the floor of a vehicle.

### BRIEF DESCRIPTION OF THE DRAWINGS

FIG. 1 is a schematic configuration diagram of a fuel cell system according to the invention.

FIG. 2 is a plan view showing an on-vehicle layout of a first embodiment.

FIG. 3 is a cross-sectional view showing the on-vehicle layout of the first embodiment.

FIG. 4 is a chart for explaining an on-vehicle layout of Example 1.

FIG. 5 is a chart for explaining an on-vehicle layout of Comparative Example 1.

FIG. 6 is a chart for explaining an on-vehicle layout of Comparative Example 2.

FIG. 7 is a chart for explaining an on-vehicle layout of a second embodiment.

### MODE FOR CARRYING OUT THE INVENTION

Firstly, the entire configuration of a first embodiment of the fuel cell system according to the invention will be described. A fuel cell system 1 is an on-vehicle power generation system for a fuel cell vehicle, and it includes a fuel cell 20, an oxidant gas supply system ASS, a fuel gas supply system FSS, a fuel cell cooling system FCCS, an electric power system ES, a converter cooling system DCCS, a controller 50, etc.

The fuel cell 20 is configured as a fuel cell stack having a predetermined number of unit cells stacked therein, each unit cell being supplied with reactant gases (fuel gas and oxidant gas) and generating electric power through electrochemical reaction. The oxidant gas supply system ASS is a system for supplying air as an oxidant gas to the fuel cell 20. The fuel gas supply system FSS is a system for supplying hydrogen gas as a fuel gas to the fuel cell 20. The electric power system ES is a system for controlling charging/discharging of electric power. The fuel cell cooling system FCCS is a system for cooling the fuel cell 20. The converter cooling system DCCS is a system for cooling a later-described DC/DC converter 41. The controller 50 is a controller that performs overall control of the entire fuel cell system 1.

The oxidant gas supply system ASS has an oxidant gas flow path 11 and an oxidant-off gas flow path 12. The oxidant gas flow path 11 is a flow path through which the oxidant gas (air) to be supplied to the cathode of the fuel cell 20 flows. The oxidant-off gas flow path 12 is a flow path through which the oxidant-off gas (air-off gas) discharged from the fuel cell 20 flows.

The oxidant gas flow path 11 is provided with an air filter A1 that removes fine particles from the air (oxidant gas), an air compressor A2 that sends the air by compressing it, a moisturizer A21 that moisturizes the air at a desired level, and a cut-off valve A3 for blocking or allowing the supply of the compressed air sent from the air compressor A2. The air filter A1 has an air flow meter (flow rate meter), not shown in the drawings, for detecting the flow rate of the air. The air compressor A2 is driven by a motor M. The driving of the motor M is controlled by the controller 50, which will be described below.

The oxidant-off gas flow path 12 is provided with a cut-off valve A4 for opening and closing the flow path at an outlet side of the fuel cell 20, a pressure regulating valve A5, and a moisturizer A21. The pressure regulating valve A5 functions as a pressure regulator (pressure reducer) that sets the pressure of the air to be supplied to the fuel cell 20. The controller 50 controls the pressure and the flow rate of the air to be supplied to the fuel cell 20 by regulating the revolution speed of the motor M that drives the air compressor A2 and the degree and area of opening of the pressure regulating valve A5.

The fuel gas supply system FSS has a hydrogen supply source 30, a fuel gas flow path 31, a circulation flow path 32, a circulation pump H13 and an exhaust/drain flow path 33. The fuel gas flow path 31 is a flow path through which the hydrogen gas (fuel gas) to be supplied from the hydrogen supply source 30 to the anode of the fuel cell 20 flows. The circulation flow path 32 is a flow path for returning the hydrogen-off gas (fuel-off gas) discharged from the fuel cell 20 back to the fuel gas flow path 31. The circulation pump H13 is a pump that compresses the hydrogen-off gas within the circulation flow path 32 and sends it to the fuel gas flow path 31. The exhaust/drain flow path 33 is a flow path connected to and branching from the circulation flow path 32.

The hydrogen supply source 30 is constituted by, for example, a high-pressure hydrogen tank which stores hydrogen gas at high pressure (e.g. 35 MPa to 70 MPa). It may be a so-called fuel reformer or hydrogen absorption alloy, etc. When a cut-off valve H1 is opened, hydrogen gas flows out from the hydrogen supply source 30 to the fuel gas flow path 31. The pressure of the hydrogen gas is reduced to, for example, about 200 kPa by a regulator H2 and an injector H3, and the resulting hydrogen gas is supplied to the fuel cell 20.

The fuel gas flow path 31 is provided with the cut-off valve H1, the regulator H2, the injector H3, and a pressure sensor, etc., not shown in the drawings. The cut-off valve H1 is a valve for blocking or allowing the supply of hydrogen gas from the hydrogen supply source 30. The regulator H2 regulates the pressure of the hydrogen gas. The injector H3 controls the amount of hydrogen gas supplied to the fuel cell 20.

The regulator H2 is a device that regulates the upstream pressure (primary pressure) to a predetermined secondary pressure, and is constituted by, for example, a mechanical pressure reducing valve for reducing the primary pressure. Such mechanical pressure reducing valve has a casing in which a backpressure chamber and a pressure regulating chamber are formed so as to be separated by a diaphragm and such valve is configured so that the primary pressure is reduced to a predetermined pressure within the pressure regulating chamber by the backpressure in the backpressure chamber, thereby obtaining the secondary pressure. By arranging the regulator H2 upstream of the injector H3, the pressure on the upstream side of the injector H3 can effectively be reduced.

The injector H3 is an electromagnetically-driven on-off valve which is configured such that a valve body is directly driven by an electromagnetic driving force with a predetermined drive period so as to be separated from a valve seat, thereby allowing the control of a gas flow rate and gas pressure. The injector H3 is provided with: a valve seat having an injection hole through which gaseous fuel such as hydrogen gas is injected; a nozzle body for supplying and guiding the gaseous fuel to the injection hole; and a valve body which is stored and held so as to be movable in the axial direction (gas flow direction) of the nozzle body and which opens/closes the injection hole.

The valve body of the injector H3 is driven by a solenoid which is an electromagnetic drive device, and is configured to be able to control the length and timing of a gas injection from the injector H3 in response to control signals output from the controller 50. In order to supply gas at a requested flow rate to the downstream side, the injector H3 changes at least one of the opening area (degree of opening) and the opening period of the valve body provided in the gas flow path of the injector H3, thereby controlling the flow rate (or hydrogen mol concentration) of the gas supplied to the downstream side.

Connected to the circulation flow path 32 via a gas-liquid separator H11 and an exhaust/drain valve H12 is the exhaust/drain flow path 33. The exhaust/drain valve H12 is a valve operated according to a command from the controller 50, thereby discharging water and hydrogen-off gas containing impurities in the circulation flow path 32 to the outside. By opening the exhaust/drain valve H12, the concentration of impurities contained in the hydrogen-off gas in the circulation flow path 32 decreases and this results in an increase of the hydrogen concentration in the hydrogen-off gas circulating through the circulation system.

The hydrogen-off gas discharged through the exhaust/drain valve H12 is mixed with the air-off gas flowing through the oxidant-off gas flow path 12 and diluted by a diluter, not shown in the drawings. The circulation pump H13 is driven by a motor and supplies the hydrogen-off gas within the circulation system to the fuel cell 20 in a circulating manner.

The electric power system ES includes a DC/DC converter 41, a traction inverter 42, a traction motor 43, a battery 44, and auxiliary devices, etc. The fuel cell system 1 is configured as a parallel hybrid system in which the DC/DC converter 41 and the traction inverter 42 are connected in parallel to the fuel cell 20. The DC/DC converter 41 is electrically connected to the traction motor 43 via the traction inverter 42.

The DC/DC converter 41 has the functions of: increasing a direct-current voltage supplied from the battery 44 and outputting it to the traction inverter 42; and decreasing the voltage of direct-current power generated by the fuel cell 20 or regenerative power collected by the traction motor 43 through regenerative braking and storing the resulting power in the battery 44. With the above functions of the DC/DC converter 41, charging/discharging of the battery 44 is controlled. Further, with the voltage conversion control by the DC/DC converter 41, the operation point (output terminal voltage, output current) of the fuel cell 20 is controlled.

A voltage sensor S1 and a current sensor S2 are attached to the fuel cell 20. The voltage sensor S1 is a sensor for detecting an output terminal voltage (cell voltage) of the fuel cell 20. The current sensor S2 is a sensor for detecting an output current of the fuel cell 20.

The battery 44 functions as: a storage source for surplus electric power; a storage source for regenerative energy during regenerative braking; and an energy buffer during a load variation due to acceleration or deceleration of the fuel cell vehicle. Suitable examples of the battery 44 include a secondary battery, such as a nickel-cadmium battery, a nickel-hydrogen battery, and a lithium secondary battery. An SOC sensor for detecting a state of charge (SOC) is attached to the battery 44.

The traction inverter 42 is, for example, a PWM inverter driven in a pulse-width modulation method. According to a control command from the controller 50, the traction inverter 42 converts a direct-current voltage output from the fuel cell 20 or from the battery 44 to a three-phase alternating current voltage, thereby controlling the rotating torque of the traction motor 43. The traction motor 43 is, for example, a three-phase alternating current motor and constitutes a power source of the fuel cell vehicle.

The auxiliary devices are peripheral devices related to the operation of the fuel cell 20. More specifically, the term auxiliary devices collectively refers to: each motor arranged at each part of the fuel cell system 1 (for example, power sources for pumps); inverters for driving such motors; and a variety of on-vehicle auxiliary devices (for example, the air compressor A2, the injector H3, a coolant pump C2, a radiator C1, etc.).

In the description hereinafter, the term “auxiliary device 45” will be used to refer to a plurality of devices including, among the above-mentioned auxiliary devices, devices particularly related to the supply/discharge of fluid to/from the fuel cell 20, in other words, devices related to the supply/discharge of air, hydrogen gas and a later-described coolant, such devices more specifically including, for example, the cut-off valves A3 and A4, the moisturizer A21 and the pressure regulating valve A5 in the oxidant gas supply system ASS, the regulator H2, the injector H3, the gas-liquid separator H11, the exhaust/drain valve H12 and the circulation pump H13 in the fuel gas supply system FSS, later-described temperature sensors T1 and T2 in the fuel cell cooling system FCCS, and the pipes or wiring connected thereto.

The fuel cell cooling system FCCS has the radiator C1, the coolant pump C2, a coolant outward path C3, and a coolant return path C4. The radiator C1 cools a coolant for cooling the fuel cell 20 by dissipating heat from the coolant. The coolant pump C2 is a pump for allowing the coolant to circulate between the fuel cell 20 and the radiator C1.

The coolant outward path C3 is a flow path connecting the radiator C1 and the fuel cell 20 and is provided with the temperature sensor T1 and the coolant pump C2. By driving the coolant pump C2, the coolant is allowed to flow from the radiator C1 to the fuel cell 20 through the coolant outward path C3. The coolant return path C4 is a flow path connecting the fuel cell 20 and the radiator C1 and is provided with the temperature sensor T2. By driving the coolant pump C2, the coolant that has cooled the fuel cell 20 is allowed to flow back to the radiator C1.

The converter cooling system DCCS has a radiator C11, a coolant pump C12, a coolant outward path C13 and a coolant return path C14. The radiator C11 cools a coolant for cooling the DC/DC converter 41 by dissipating heat from the coolant. The coolant pump C12 is a pump for allowing the coolant to circulate between the DC/DC converter 41 and the radiator C11.

The coolant outward path C13 is a flow path connecting the radiator

C11 and the DC/DC converter 41 and is provided with a temperature sensor T11 and the coolant pump C12. By driving the coolant pump C12, the coolant is allowed to flow from the radiator C11 to the DC/DC converter 41 through the coolant outward path C13. The coolant return path C14 is a flow path connecting the DC/DC converter 41 and the radiator C11 and is provided with a temperature sensor T12. By driving the coolant pump C12, the coolant that has cooled the DC/DC converter 41 is allowed to flow back to the radiator C11.

The controller 50 is a computer system having a CPU, ROM, RAM and input/output interface, and it controls each part of the fuel cell system 1. For example, when the controller 50 receives an ignition signal IG output from an ignition switch, it starts the operation of the fuel cell system 1. After that, the controller 50 determines required power from the entire fuel cell system 1 based on, for example, signals ACC output from an accelerator sensor regarding the degree of opening of the accelerator and signals VC output from a vehicle speed sensor regarding the speed of the vehicle.

The controller 50 determines an output power distribution between the fuel cell 20 and the battery 44, controls the oxidant gas supply system ASS and the fuel gas supply system FSS so that the amount of power generated by the fuel cell 20 agrees with a target power and also controls the DC/DC converter 41 to control the operation point (output terminal voltage, output current) of the fuel cell 20.

Further, in order to obtain a target torque according to the degree of opening of the accelerator, for example, the controller 50 outputs, as switching commands, respective AC voltage command values for a U-phase, V-phase and W-phase to the traction inverter 42, and controls the output torque and revolution speed of the traction motor 43. Still further, the controller 50 controls the fuel cell cooling system FCCS and the converter cooling system DCCS so that the fuel cell 20 and the DC/DC converter 41 are maintained at a suitable temperature.

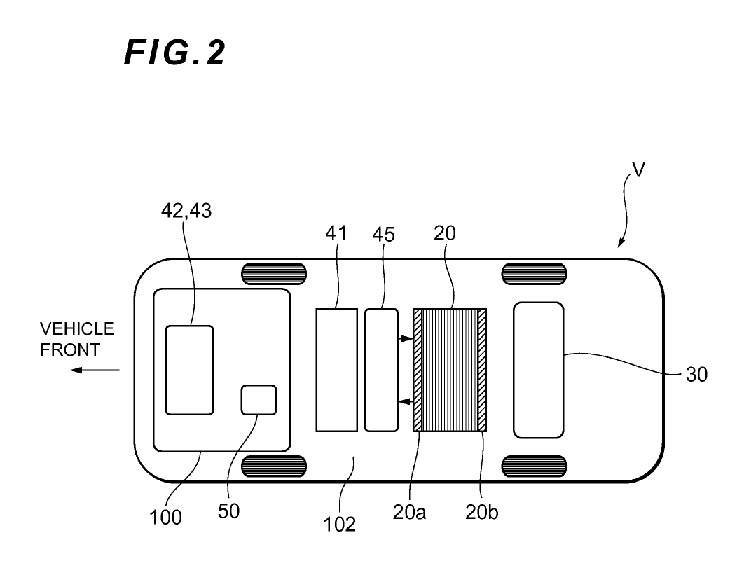

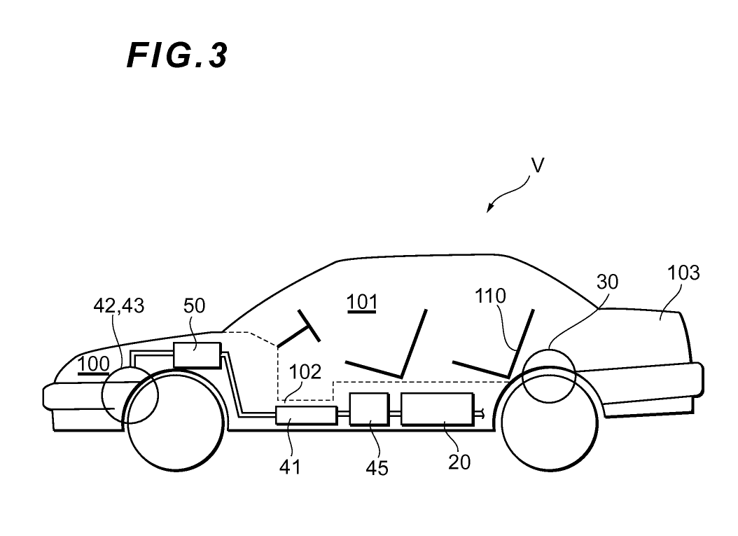

Next, the on-vehicle layout of the fuel cell system 1 according to this embodiment will be described, with reference to FIGS. 2 and 3.

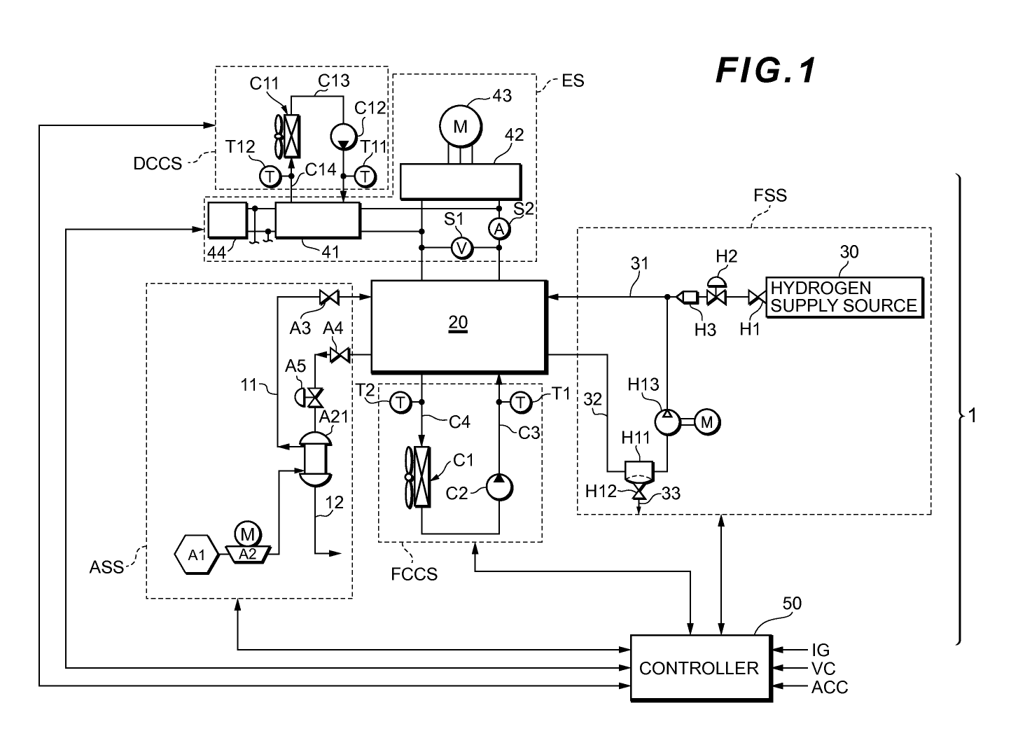

Arranged in a compartment 100 formed at the front section of a vehicle (fuel cell vehicle) V are the traction inverter 42, traction motor 43 and controller 50. Although not shown in FIGS. 2 and 3, the air filter A1, air compressor A2, radiator C1 and radiator C11 shown in FIG. 1 are also arranged in the compartment 100.

In the back of the compartment 100, under the floor of the vehicle, namely, in an underfloor space 102 under a vehicle interior 101, the DC/DC converter 41, the auxiliary device 45 and the fuel cell 20 are serially arranged in this order from the front in the front-back direction of the vehicle, such that the vertical and horizontal positions thereof almost conform to each other.

The fuel cell 20 is disposed such that one end plate 20a in the stacking direction of the unit cells (one end in the cell stacking direction) faces the front side of the vehicle and the other end plate 20b (the other end in the cell stacking direction) faces the back side of the vehicle. Note that the fuel cell 20 in this embodiment is configured such that connection parts for the pipes to the fuel cell 20 are all provided at the end plate 20a facing the front side of the vehicle. The fuel cell 20 is also configured such that the end plate 20a side is the total-negative electrode of the fuel cell 20 and the opposite side, i.e., the end plate 20b side is the total-positive electrode.

The hydrogen supply source 30 is arranged at a position in the back of the fuel cell 20 in the vehicle, for example, a position not under a seat back 110 of the rear seat but rather closer to a trunk 103 (see FIG. 3).

According to the above-described first embodiment, the fuel cell 20 to be arranged under the floor of the vehicle, the DC/DC converter 41, also to be arranged under the floor, and the auxiliary device 45 for the fuel cell 20, also to be arranged under the floor, are serially arranged in the order of the DC/DC converter 41, the auxiliary device 45 and the fuel cell 20 from the front in the front-back direction of the vehicle. Accordingly, the DC/DC converter 41, the auxiliary device 45 and the fuel cell 20 can efficiently be arranged in a space under the floor of the vehicle which is narrow in the vehicle-width direction and the vertical direction.

Accordingly, the fuel cell 20 and the DC/DC converter 41 can be mounted by making use of the width between the side members under the floor. Further, since the fuel cell 20 can be arranged at the back side of the vehicle, a limitation in the height direction posed by the cross members at the foot of the front seat (driver seat, front passenger seat) can be avoided, and a certain cell height can be ensured for the fuel cell 20.

In order to verify the advantageous effects obtained by the arrangement of the first embodiment, Example 1 in which the DC/DC converter 41, the auxiliary device 45 and the fuel cell 20 are serially arranged in this order from the front in the front-back direction of the vehicle is compared with Comparative Example 1 in which the auxiliary device 45, the fuel cell 20 and the DC/DC converter 41 are serially arranged in this order from the front in the front-back direction of the vehicle and Comparative Example 2 in which the auxiliary device 45, the DC/DC converter 41 and the fuel cell 20 are serially arranged in this order from the front in the front-back direction of the vehicle.

Note that, among the components of the fuel cell system 1, the fuel cell 20 is one of the largest in terms of size, while the auxiliary device 45 and the DC/DC converter 41 are relatively large parts but are smaller than the fuel cell 20.

### Example 1

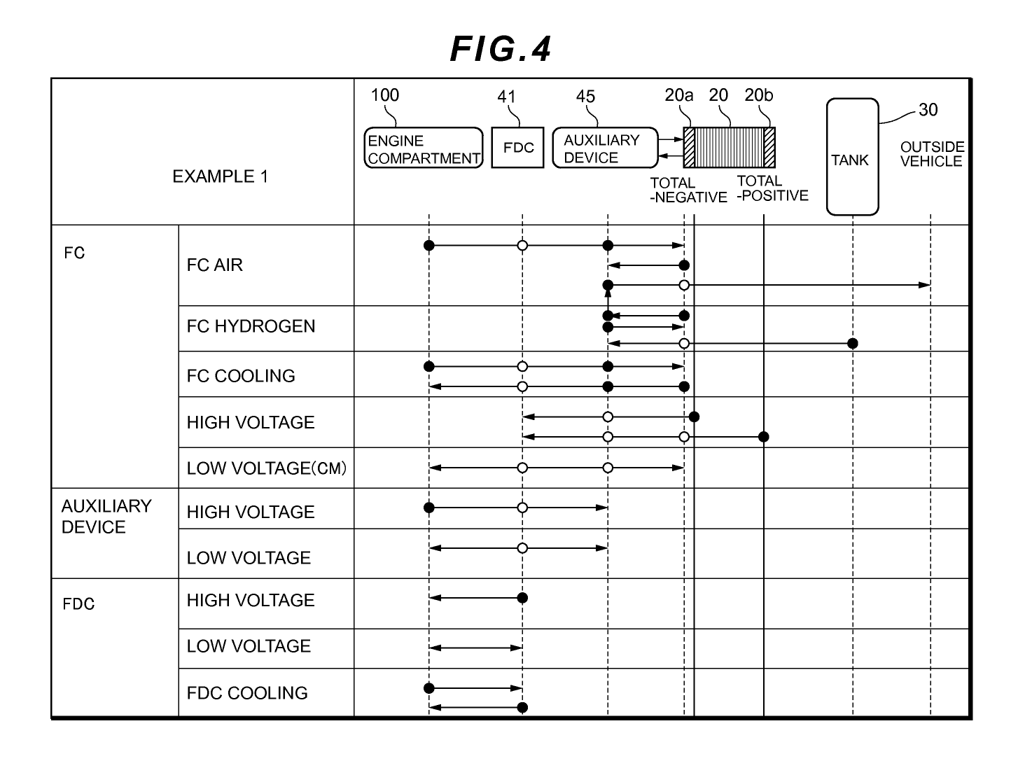

Firstly, the on-vehicle layout of Example 1 will be described, referring to FIG. 4.

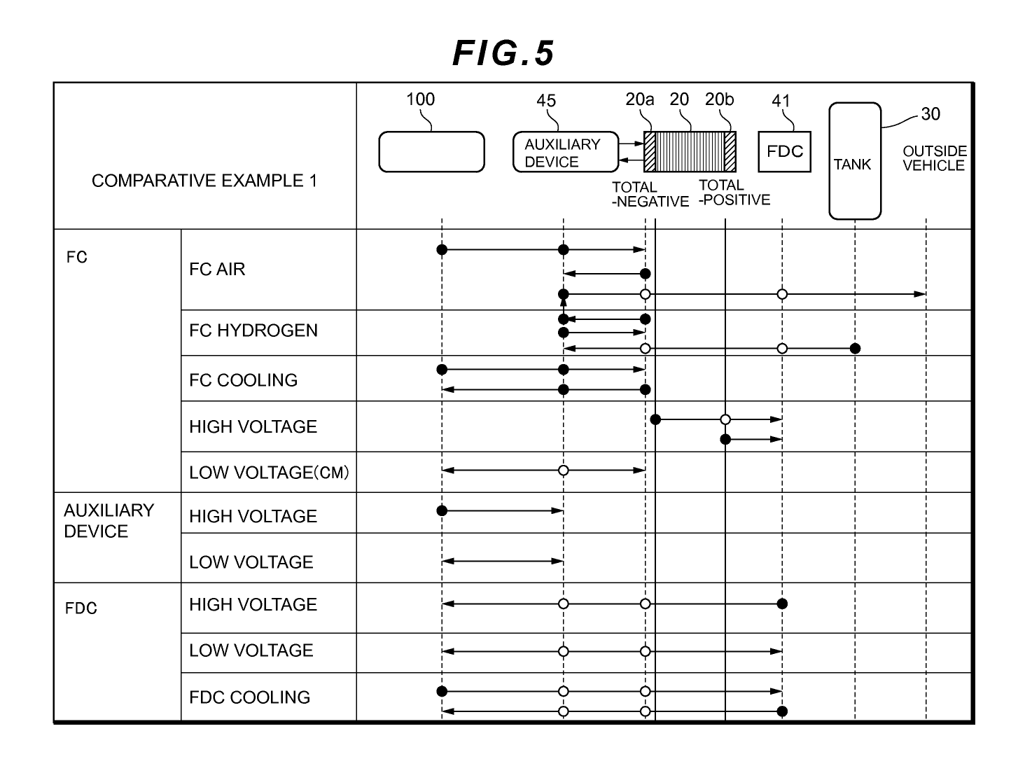

In FIG. 4, “FC,” “FC Air,” “FC Hydrogen,” “FC Cooling,” “High Voltage,” “Low Voltage,” “Auxiliary Device,” “FDC” and “FDC Cooling” represent the fuel cell 20, the oxidant gas supply system ASS, the fuel gas supply system FSS, the fuel cell cooling system FCCS, the wiring of a high voltage system (main power source line), the wiring of a low voltage system (12V battery system), the auxiliary device 45, the DC/DC converter 41 and the converter cooling system DCCS, respectively (the above also applies to FIGS. 5-7 described later).

In FIG. 4, the black circles represent portions (system components) to which the pipe or wiring needs to be connected, and the white circles represent portions (system components) which the pipe or wiring needs to traverse (the above also applies to FIGS. 5-7 described later).

### “FC Air” in the “FC” Items

The oxidant gas flow path 11 for supplying the air introduced through the air filter A1 arranged in the compartment 100 to the fuel cell 20 is formed with a pipe having a larger diameter than that of the pipe in the fuel gas supply system FSS. The above pipe extends from the compartment 100 into the underfloor space, traverses the DC/DC converter 41 in the vehicle-width direction (hereinafter, “traverse . . . in the vehicle-width direction” is also described simply as “traverse”), connects with the moisturizer A21 and the cut-off valve A3 comprised in the auxiliary device 45, and connects with the fuel cell 20.

Similarly to the pipe for the oxidant gas flow path 11, the pipe forming the oxidant-off gas flow path 12 for directing the air-off gas discharged from the fuel cell 20 to the outside of the vehicle has a larger diameter than that of the pipe in the fuel gas supply system FSS. The above pipe extends, under the floor, from the fuel cell 20, connects with the cut-off valve A4, the pressure regulating valve A5 and the moisturizer A21 comprised in the auxiliary device 45, then traverses the fuel cell 20 so as to extend to the back side of the hydrogen supply source 30 and finally forms an opening to the outside of the vehicle.

### “FC Hydrogen” in the “FC” Items

The fuel gas flow path 31 for supplying hydrogen gas to the fuel cell 20 from the hydrogen supply source 30 arranged at the back of the vehicle is formed with a pipe having a smaller diameter than that of the pipe in the oxidant gas supply system ASS. The above pipe extends from the back side of the vehicle into the underfloor space, traverses the fuel cell 20, connects with the regulator H2 and the injector H3 comprised in the auxiliary device 45, and connects with the fuel cell 20.

Similarly to the pipe for the fuel gas flow path 31, the pipe forming the circulation flow path 32 for returning the hydrogen-off gas discharged from the fuel cell 20 back to the fuel gas flow path 31 has a smaller diameter than that of the pipe in the oxidant gas supply system ASS. The above pipe extends, under the floor, from the fuel cell 20, connects with the gas-liquid separator H11 and the exhaust/drain valve H12 comprised in the auxiliary device 45, and connects with the oxidant-off gas flow path 12.

### “FC Cooling” in the “FC” Items

The coolant outward path C3 for introducing the coolant from the radiator C1 arranged in the compartment 100 to the fuel cell 20 with the coolant pump C2 is formed with a pipe having a larger diameter than that of the pipe in the fuel gas supply system FSS. The above pipe extends from the compartment 100 into the underfloor space, traverses the DC/DC converter 41, connects with the temperature sensor T1 comprised in the auxiliary device 45, and connects with the fuel cell 20.

Similarly to the pipe for the coolant outward path C3, the pipe forming the coolant return path C4 for directing the coolant from the fuel cell 20 into the radiator C1 has a larger diameter than that of the pipe in the fuel gas supply system FSS. The above pipe extends, under the floor, from the fuel cell 20, connects with the temperature sensor T2 comprised in the auxiliary device 45, traverses the DC/DC converter 41 into the compartment 100, and connects with the radiator C1.

### “High Voltage” in the “FC” Items

The high voltage wiring from the total-negative electrode on the end plate 20a side of the fuel cell 20 (hereinafter, “FC system high voltage wiring”) is an electric cable whose diameter is smaller than that of the pipe in the oxidant gas supply system ASS and the fuel cell cooling system FCCS. The above cable extends, under the floor, from the end plate 20a of the fuel cell 20, traverses the auxiliary device 45, and connects with the DC/DC converter 41.

Similarly to the FC system high voltage wiring from the total-negative electrode, the FC system high voltage wiring from the total-positive electrode on the end plate 20b side of the fuel cell 20 is an electric cable whose diameter is smaller than that of the pipe in the oxidant gas supply system ASS and the fuel cell cooling system FCCS. The above cable extends, under the floor, from the end plate 20b of the fuel cell 20, traverses the fuel cell 20 and the auxiliary device 45, and connects with the DC/DC converter 41.

### “Low Voltage (CM)” in the “FC” Items

The low voltage wiring for measuring a cell voltage, which extends from the end plate 20a side of the fuel cell 20 (hereinafter, “FC system low voltage wiring”), is a group of electric cables having a smaller diameter than that of the pipe in the oxidant gas supply system ASS and the fuel cell cooling system FCCS. The above group of cables traverses the auxiliary device 45 and the DC/DC converter 41 under the floor, extends into the compartment 100, and connects with the controller 50.

### “High Voltage” in the “Auxiliary Device” Items

The high voltage wiring from the traction inverter 42 arranged in the compartment 100 (hereinafter, “auxiliary device system high voltage wiring”) is an electric cable having a larger diameter than the electric cables of the FC system high voltage wiring and the FC system low voltage wiring. The above cable extends from the compartment 100 into the underfloor space, traverses the DC/DC converter 41, and connects with the circulation pump H13 comprised in the auxiliary device 45.

### “Low Voltage” in the “Auxiliary Device” Items

Similarly to the auxiliary device system high voltage wiring, the low voltage wiring from the controller 50 arranged in the compartment 100 (hereinafter, “auxiliary device system low voltage wiring”) is an electric cable having a larger diameter than the electric cables of the FC system high voltage wiring and the FC system low voltage wiring. The above electric cable extends from the compartment 100 into the underfloor space, traverses the DC/DC converter 41, and connects with the valves and sensors comprised in the auxiliary device 45.

### “High Voltage” in the “FDC” Items

The high voltage wiring from the DC/DC converter 41 (hereinafter, “FDC system high voltage wiring”) is an electric cable having a larger diameter than the electric cables of the FC system high voltage wiring and the FC system low voltage wiring. The above electric cable extends from the underfloor space into the compartment 100 and connects with the traction motor 43 via the traction inverter 42.

### “Low Voltage” in the “FDC” Items

Similarly to the FDC system high voltage wiring, the low voltage wiring from the DC/DC converter 41 (hereinafter, “FDC system low voltage wiring”) is a signal line having a larger diameter than the electric cables of the FC system high voltage wiring and the FC system low voltage wiring. The signal line extends from the underfloor space into the compartment 100 and connects with the controller 50.

### “FDC Cooling” in the “FDC” Items

The coolant outward path C13 for supplying the coolant from the radiator C11 arranged in the compartment 100 to the DC/DC converter 41 with the coolant pump C12 is formed with a pipe having a smaller diameter than the pipe in the fuel cell cooling system FCCS. The above pipe extends from the compartment 100 into the underfloor space and connects with the DC/DC converter 41.

Similarly to the coolant outward path C13, the coolant return path C14 for directing the coolant from the DC/DC converter 41 into the radiator C11 is formed with a pipe having a smaller diameter than the pipe in the fuel cell cooling system FCCS. The above pipe extends from the underfloor space into the compartment 100 and connects with the radiator C11.

As described above, in Example 1, although the connection relationship (routing) of the pipes and wiring between the DC/DC converter 41, the auxiliary device 45 and the fuel cell 20 includes crossing only in the wiring between the fuel cell 20 and the DC/DC converter 41, the other portions are not redundant and the routing is, thus, favorable.

### Comparative Example 1

Next, the on-vehicle layout of Comparative Example 1 will be described, referring to FIG. 5.

### “FC Air” in the “FC” Items

The pipe forming the oxidant gas flow path 11 for supplying the air introduced through the air filter A1 arranged in the compartment 100 to the fuel cell 20 extends from the compartment 100 into the underfloor space, connects with the moisturizer A21 and the cut-off valve A3 comprised in the auxiliary device 45, and connects with the fuel cell 20.

The pipe forming the oxidant-off gas flow path 12 for directing the air-off gas discharged from the fuel cell 20 to the outside of the vehicle extends, under the floor, from the fuel cell 20, connects with the cut-off valve A4, the pressure regulating valve A5 and the moisturizer A21 comprised in the auxiliary device 45, traverses the fuel cell 20 and the DC/DC converter 41 so as to extend to the back side of the hydrogen supply source 30, and finally forms an opening to the outside of the vehicle.

### “FC Hydrogen” in the “FC” Items

The pipe forming the fuel gas flow path 31 for supplying hydrogen gas from the hydrogen supply source 30 arranged at the back of the vehicle to the fuel cell 20 extends from the back of the vehicle into the underfloor space, traverses the DC/DC converter 41 and the fuel cell 20, connects with the regulator H2 and the injector H3 comprised in the auxiliary device 45, and connects with the fuel cell 20.

Further, the pipe forming the circulation flow path 32 for returning the hydrogen-off gas discharged from the fuel cell 20 back to the fuel gas flow path 31 extends, under the floor, from the fuel cell 20, connects with the gas-liquid separator H11 and the exhaust/drain valve H12 comprised in the auxiliary device 45, and connects with the oxidant-off gas flow path 12.

### “FC Cooling” in the “FC” Items

The pipe forming the coolant outward path C3 for introducing the coolant from the radiator C1 arranged in the compartment 100 into the fuel cell 20 with the coolant pump C2 extends from the compartment 100 into the underfloor space, connects with the temperature sensor T1 comprised in the auxiliary device 45, and connects with the fuel cell 20.

Further, the pipe forming the coolant return path C4 for directing coolant from the fuel cell 20 into the radiator C1 extends, under the floor, from the fuel cell 20, connects with the temperature sensor T2 comprised in the auxiliary device 45, extends into the compartment 100, and connects with the radiator C1.

### “High Voltage” in the “FC” Items

The FC system high voltage wiring from the total-negative electrode on the end plate 20a side of the fuel cell 20 extends, under the floor, from the end plate 20a of the fuel cell 20, traverses the fuel cell 20, and connects with the DC/DC converter 41.

The FC system high voltage wiring from the total-positive electrode on the end plate 20b side of the fuel cell 20 extends, under the floor, from the end plate 20b of the fuel cell 20 and connects with the DC/DC converter 41.

### “Low Voltage (CM)” in the “FC” Items

The FC system low voltage wiring for measuring a cell voltage, which extends from the end plate 20a side of the fuel cell 20, extends, under the floor, from the end plate 20a of the fuel cell 20, traverses the auxiliary device 45 into the compartment 100, and connects with the controller 50.

### “High Voltage” in the “Auxiliary Device” Items

The auxiliary device system high voltage wiring from the traction inverter 42 arranged in the compartment 100 extends from the compartment 100 into the underfloor space and connects with the circulation pump H13 comprised in the auxiliary device 45.

### “Low Voltage” in the “Auxiliary Device” Items

The auxiliary device system low voltage wiring from the controller 50 arranged in the compartment 100 extends from the compartment 100 into the underfloor space and connects with the valves and sensors comprised in the auxiliary device 45.

### “High Voltage” in the “FDC” Items

The FDC system high voltage wiring from the DC/DC converter 41 traverses the fuel cell 20 and the auxiliary device 45 under the floor, extends into the compartment 100, and connects with the traction motor 43 via the traction inverter 42.

### “Low Voltage” in the “FDC” Items

The FDC system low voltage wiring from the DC/DC converter 41 traverses the fuel cell 20 and the auxiliary device 45 under the floor, extends into the compartment 100, and connects with the controller 50.

### “FDC Cooling” in the “FDC” Items

The pipe forming the coolant outward path C13 for supplying the coolant from the radiator C11 arranged in the compartment 100 to the DC/DC converter 41 with the coolant pump C12 extends from the compartment 100 into the underfloor space, traverses the auxiliary device 45 and the fuel cell 20, and connects with the DC/DC converter 41.

Further, the pipe forming the coolant return path C14 for directing the coolant from the DC/DC converter 41 into the radiator C11 traverses the fuel cell 20 and the auxiliary device 45 under the floor, extends into the compartment 100, and connects with the radiator C11.

In Comparative Example 1, the routing between the auxiliary device 45, the fuel cell 20 and the DC/DC converter 41 does not include crossing and is, thus, favorable. Further, the fuel cell 20 and the DC/DC converter 41 can be mounted by making use of the width between the side members under the floor.

However, since the fuel cell 20 is not arranged at the back side of the vehicle, a limitation in the height direction posed by the cross members at the foot of the front seat (driver seat, front passenger seat) cannot be avoided and a certain cell height of the fuel cell 20 cannot be ensured. The DC/DC converter 41 has disadvantages in the height direction, and the wiring to the DC/DC converter 41 traverses the auxiliary device 45 and the fuel cell 20 numerous times.

### Comparative Example 2

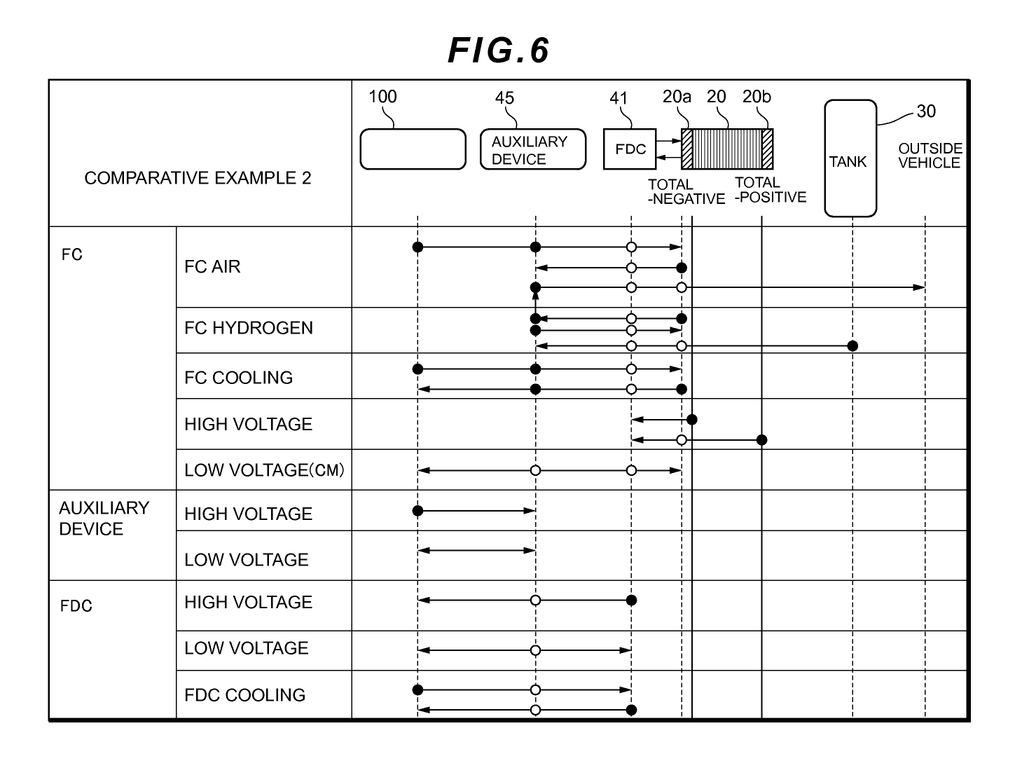

Next, the on-vehicle layout of Comparative Example 2 will be described, referring to FIG. 6.

### “FC Air” in the “FC” Items

The pipe forming the oxidant gas flow path 11 for supplying the air introduced through the air filter A1 arranged in the compartment 100 to the fell cell 20 extends from the compartment 100 into the underfloor space, connects with the moisturizer A21 and the cut-off valve A3 comprised in the auxiliary device 45, traverses the DC/DC converter 41, and connects with the fuel cell 20.

Further, the pipe forming the oxidant-off gas flow path 12 for directing the air-off gas discharged from the fuel cell 20 to the outside of the vehicle extends, under the floor, from the fuel cell 20, traverses the DC/DC converter 41, connects with the cut-off valve A4, the pressure regulating valve A5 and the moisturizer A21 comprised in the auxiliary device 45, traverses the DC/DC converter 41 and the fuel cell 20 so as to extend to the back side of the hydrogen supply source 30, and finally forms an opening to the outside of the vehicle.

### “FC Hydrogen” in the “FC” Items

The pipe forming the fuel gas flow path 31 for supplying hydrogen gas from the hydrogen supply source 30 arranged at the back of the vehicle to the fuel cell 20 extends from the back of the vehicle into the underfloor space, traverses the fuel cell 20 and the DC/DC converter 41, connects with the regulator H2 and the injector H3 comprised in the auxiliary device 45, and connects with the fuel cell 20.

Further, the pipe forming the circulation flow path 32 for returning the hydrogen-off gas discharged from the fuel cell 20 back to the fuel gas flow path 31 extends, under the floor, from the fuel cell 20, traverses the DC/DC converter 41, connects with the gas-liquid separator H11 and the exhaust/drain valve H12 comprised in the auxiliary device 45, and connects with the oxidant-off gas flow path 12.

### “FC Cooling” in the “FC” Items

The pipe forming the coolant outward path C3 for introducing the coolant from the radiator C1 arranged in the compartment 100 into the fuel cell 20 with the coolant pump C2 extends from the compartment 100 into the underfloor space, connects with the temperature sensor T1 comprised in the auxiliary device 45, traverses the DC/DC converter 41, and connects with the fuel cell 20.

Further, the pipe forming the coolant return path C4 for directing the coolant from the fuel cell 20 into the radiator C1 extends, under the floor, from the fuel cell 20, traverses the DC/DC converter 41, connects with the temperature sensor T2 comprised in the auxiliary device 45, extends into the compartment 100, and connects with the radiator C1.

### “High Voltage” in the “FC” Items

The FC system high voltage wiring from the total-negative electrode on the end plate 20a side of the fuel cell 20 extends, under the floor, from the end plate 20a of the fuel cell 20 and connects with the DC/DC converter 41.

The FC system high voltage wiring from the total-positive electrode on the end plate 20b side of the fuel cell 20 extends, under the floor, from the end plate 20b of the fuel cell 20, traverses the fuel cell 20, and connects with the DC/DC converter 41.

### “Low Voltage (CM)” in the “FC” Items

The FC system low voltage wiring for measuring a cell voltage, which extends from the end plate 20a side of the fuel cell 20, extends, under the floor, from the end plate 20a of the fuel cell 20, traverses the DC/DC converter 41 and the auxiliary device 45 into the compartment 100, and connects with the controller 50.

### “High Voltage” in the “Auxiliary Device” Items

The auxiliary device system high voltage wiring from the traction inverter 42 arranged in the compartment 100 extends from the compartment 100 into the underfloor space and connects with the circulation pump H13 comprised in the auxiliary device 45.

### “Low Voltage” in the “Auxiliary Device” Items

The auxiliary device system low voltage wiring from the controller 50 arranged in the compartment 100 extends from the compartment 100 into the underfloor space and connects with the valves and sensors comprised in the auxiliary device 45.

### “High Voltage” in the “FDC” Items

The FDC system high voltage wiring from the DC/DC converter 41 traverses the auxiliary device 45 under the floor, extends into the compartment 100, and connects with the traction motor 43 via the traction inverter 42.

### “Low Voltage” in the “FDC” Items

The FDC system low voltage wiring from the DC/DC converter 41 traverses the auxiliary device 45 under the floor, extends into the compartment 100, and connects with the controller 50.

### “FDC Cooling” in the “FDC” Items

The pipe forming the coolant outward path C13 for supplying the coolant from the radiator C11 arranged in the compartment 100 to the DC/DC converter 41 with the coolant pump C12 extends from the compartment 100 into the underfloor space, traverses the auxiliary device 45, and connects with the DC/DC converter 41.

Further, the pipe forming the coolant return path C14 for directing the coolant from the DC/DC converter 41 into the radiator C11 traverses the auxiliary device 45 under the floor, extends into the compartment 100, and connects with the radiator C11.

In Comparative Example 2, the fuel cell 20 and the DC/DC converter 41 can be mounted by making use of the width between the side members under the floor. However, the pipes between the auxiliary device 45 and the fuel cell 20 traverse the DC/DC converter 41 and the wiring between the DC/DC converter 41 and the compartment 100 traverses the auxiliary device 45, so there is a high degree of crossing involved.

As described above, in Comparative Example 1, since the DC/DC converter 41 is arranged at the back of the fuel cell 20, the wiring and pipes connecting the DC/DC converter 41 and the compartment 100 need to traverse the auxiliary device 45 and the fuel cell 20; whereas, in Example 1, since the DC/DC converter 41 is arranged at the front of the auxiliary device 45, the wiring and pipes connecting the DC/DC converter 41 and the compartment 100 do not need to traverse the auxiliary device 45 and the fuel cell 20.

Accordingly, the fuel cell 20, the auxiliary device 45 and the DC/DC converter 41 can be efficiently arranged in the underfloor space of the vehicle which is narrow in the vehicle-width direction.

Further, in Comparative Example 2, since the DC/DC converter 41 is arranged at the back of the auxiliary device 45, the wiring and pipes connecting the DC/DC converter 41 and the compartment 100 need to traverse the auxiliary device 45; whereas, in Example 1, since the DC/DC converter 41 is arranged at the front of the auxiliary device 45, the wiring and pipes connecting the DC/DC converter 41 and the compartment 100 do not need to traverse the auxiliary device 45.

Accordingly, the fuel cell 20, the auxiliary device 45 and the DC/DC converter 41 can be efficiently arranged in the underfloor space of the vehicle which is narrow in the vehicle-width direction.

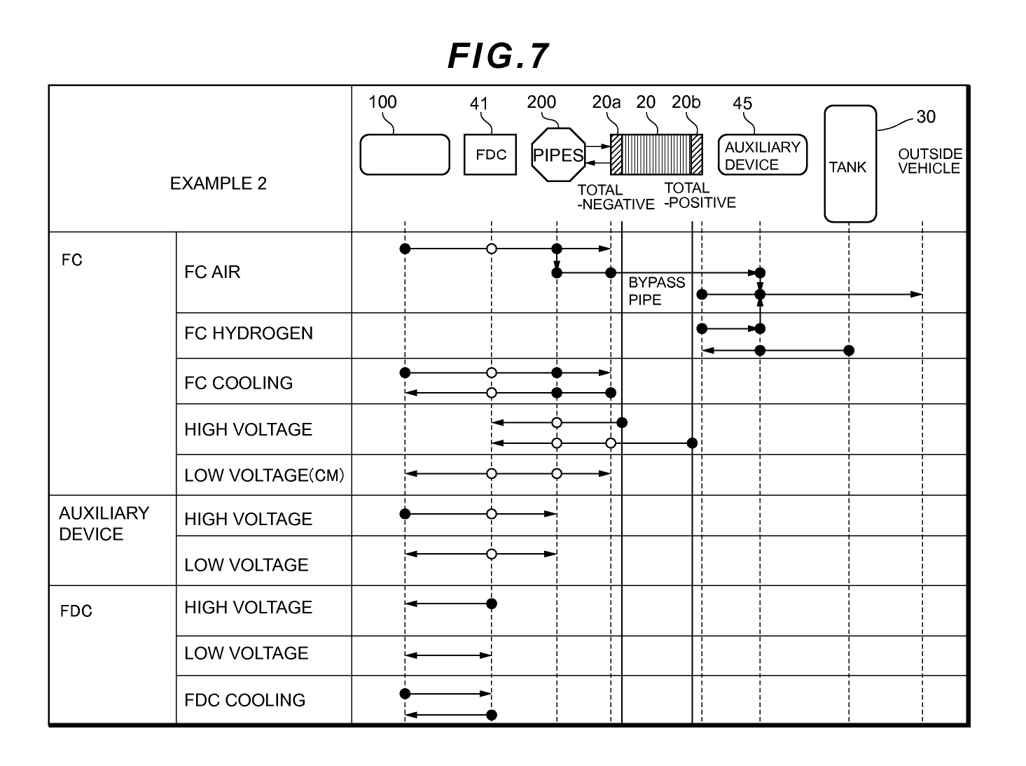

Next, referring mainly to FIG. 7, a second embodiment of the fuel cell system according to the invention will be described, mainly with regard to the differences from the first embodiment.

In the second embodiment, in the back of the compartment 100, under the floor of the vehicle, the DC/DC converter 41, the fuel cell 20 and the auxiliary device 45 are serially arranged in this order from the front in the front-back direction of the vehicle, such that the vertical and horizontal positions thereof almost conform to each other. Further, the hydrogen supply source 30 is arranged in the back of the auxiliary device 45 in the vehicle.

In the second embodiment, the oxidant gas flow path 11 of the oxidant gas supply system ASS and the fuel cell cooling system FCCS are connected to one end plate of the fuel cell 20, namely, the end plate 20a facing the compartment 100; while the oxidant-off gas flow path 12 of the oxidant gas supply system ASS and the fuel gas supply system FSS are connected to the other end plate of the fuel cell 20, namely, the end plate 20b facing the hydrogen supply source 30.

The oxidant gas flow path 11, the coolant outward path C3 and the coolant return path C4 which are connected to the end plate 20a are configured as one group of pipes 200. Meanwhile, the regulator H2, the injector H3, the gas-liquid separator H11, the exhaust/drain valve H12, the circulation pump H13, and the pipes and wiring connected thereto are configured as the auxiliary device 45, as one group.

Accordingly, the auxiliary device 45 and the group of pipes 200 in this embodiment are each a system component even smaller in size than the auxiliary device 45 in the first embodiment.

According to the above-described second embodiment, the fuel cell 20 to be arranged under the floor of the vehicle, the DC/DC converter 41, also to be arranged under the floor, and the auxiliary device 45, also to be arranged under the floor, are serially arranged in the order of the DC/DC converter 41, the fuel cell 20 and the auxiliary device 45 from the front in the front-back direction of the vehicle. Thus, like in the first embodiment, although the connection relationship (routing) of the pipes and wiring between the converter, the auxiliary device and the fuel cell has a crossing portion only in the wiring between the fuel cell and the converter, the other portions are not redundant and the routing is, thus, favorable.

Accordingly, the DC/DC converter 41, the fuel cell 20 and the auxiliary device 45 can be efficiently arranged in the underfloor space of the vehicle which is narrow in the vehicle-width direction.

In addition, the entire size of the auxiliary device 45 is small compared to that in the first embodiment since the group of pipes 200 is separated from the auxiliary device 45. Thus, the passage in the fuel gas supply system FSS is shortened and the routing of the pipes becomes far easier. However, because the space for the auxiliary device 45 and the space for the group of pipes 200 are separated, a constraint is posed on the length of the fuel cell 20 and the DC/DC converter 41 in the front-back direction of the vehicle, and thus, the first embodiment is more advantageous in terms of performance and ease of mounting.

In the second embodiment, since the DC/DC converter 41 is arranged at the front of the fuel cell 20 and the auxiliary device 45, the wiring and pipes connecting the DC/DC converter 41 and the compartment 100 do not need to traverse the auxiliary device 45 and the fuel cell 20. Accordingly, the fuel cell 20, the auxiliary device 45 and the DC/DC converter 41 can be efficiently arranged in the underfloor space of the vehicle which is narrow in the vehicle-width direction.

Next, in order to more clearly describe how the advantageous effects of the configuration of the invention can be obtained, other comparative examples will be briefly described below, although detailed descriptions thereof will be omitted.

In a parallel arrangement in which the auxiliary device is arranged at one side of the fuel cell and the DC/DC converter is arranged at the other side, the distance between the fuel cell and the DC/DC converter is small and it is, thus, easy to make the electric connection between them. However, the pipes between the fuel cell and the auxiliary device include numerous bending portions, resulting in the passage having many wasted portions. Further, such arrangement is not possible in a space which is narrow in the vehicle-width direction.

In another parallel arrangement in which the auxiliary device is arranged at one side of the fuel cell and the DC/DC converter is arranged at a side of the auxiliary device opposite to the fuel cell, the fuel cell and the DC/DC converter have the auxiliary device between them and the electric connection therebetween has many wasted portions. Further, the pipes between the fuel cell and the auxiliary device include numerous bending portions, resulting in the passage having many wasted portions. Moreover, such arrangement is not possible in a space which is narrow in the vehicle-width direction.

In another parallel arrangement in which the DC/DC converter is arranged at one side of the fuel cell and the auxiliary device is arranged at a side of the DC/DC converter opposite to the fuel cell, since the fuel cell and the auxiliary device have the DC/DC converter between them, the distance between them is long and the passage has many wasted portions. Moreover, such arrangement is not possible in a space which is narrow in the vehicle-width direction.

When the DC/DC converter is arranged in a parallel manner at one side of the fuel cell and the auxiliary device is serially arranged at the front of the fuel cell in the vehicle, the pipes do not extend back and forth and, thus, such arrangement is favorable. However, such arrangement is not possible in a space which is narrow in the vehicle-width direction.

When the DC/DC converter is arranged in a parallel manner at one side of the fuel cell and the auxiliary device is serially arranged at the back of the fuel cell in the vehicle, the auxiliary device and the end plate of the fuel cell to be connected to the pipes are on opposite sides and, thus, the routing of the pipes becomes redundant. Further, such arrangement is not possible in a space which is narrow in the vehicle-width direction.

When the auxiliary device is arranged in a parallel manner at one side of the fuel cell and the DC/DC converter is serially arranged at the back of the fuel cell in the vehicle, the wiring between the fuel cell and the DC/DC converter does not have many crossing portions and, thus, such arrangement is favorable. However, the pipes between the fuel cell and the auxiliary device include numerous bending portions, resulting in the passage having many wasted portions. Further, such arrangement is not possible in a space which is narrow in the vehicle-width direction.

When the auxiliary device is arranged in a parallel manner at one side of the fuel cell and the DC/DC converter is serially arranged at the front of the fuel cell in the vehicle, the DC/DC converter is in the middle of the routing to the auxiliary device and, thus, such arrangement is disadvantageous in terms of routing. Further, the pipes between the fuel cell and the auxiliary device include numerous bending portions, resulting in the passage having many wasted portions. In addition, such arrangement is not possible in a space which is narrow in the vehicle-width direction.

When the auxiliary device is serially arranged at the back of the fuel cell in the vehicle and the DC/DC converter is serially arranged at the front of the fuel cell in the vehicle, the auxiliary device and the end plate of the fuel cell to be connected to the pipes are on opposite sides and, thus, the routing of the pipes becomes redundant.

When the DC/DC converter is serially arranged at the back of the fuel cell in the vehicle and the auxiliary device is serially arranged at the back of the DC/DC converter in the vehicle, the auxiliary device and the end plate of the fuel cell to be connected to the pipes are on opposite sides and further, the DC/DC converter is placed between them. Accordingly, the routing of the pipes becomes redundant.

When the auxiliary device is serially arranged at the back of the fuel cell in the vehicle and the DC/DC converter is serially arranged at the back of the auxiliary device in the vehicle, the auxiliary device and the end plate of the fuel cell to be connected to the pipes are on opposite sides and, thus, the routing of the pipes becomes redundant.

### DESCRIPTION OF REFERENCE NUMERALS

1 Fuel cell system

20 Fuel cell

41 DC/DC converter (converter)

43 Traction motor

45 Auxiliary device

50 Controller

100 Compartment

101 Vehicle interior

102 Underfloor space

A2 Air compressor

C1, C11 Radiator

V Vehicle (fuel cell vehicle)

1.-5. (canceled)

6. A fuel cell system for a vehicle, comprising, under a floor of the vehicle:
a fuel cell which is supplied with an oxidant gas and a fuel gas and which generates electric power through an electrochemical reaction;
an auxiliary device related to the operation of the fuel cell; and
a converter that converts electric power generated by the fuel cell,
wherein the fuel cell, the auxiliary device and the converter are arranged serially in a front-back direction of the vehicle and the auxiliary device is arranged so as to be adjacent to the fuel cell,
wherein the fuel cell is formed by stacking a predetermined number of unit cells, each unit cell being supplied with the oxidant gas and the fuel gas and generating electric power through the electrochemical reaction, and the oxidant gas and the fuel gas are supplied and discharged at one end of the fuel cell in the cell stacking direction, and
wherein the converter, the auxiliary device and the fuel cell are serially arranged in this order from the front in the front-back direction of the vehicle.

7. A fuel cell system for a vehicle, comprising, under a floor of the vehicle:
a fuel cell which is supplied with an oxidant gas and a fuel gas and which generates electric power through an electrochemical reaction;
an auxiliary device related to the operation of the fuel cell; and
a converter that converts electric power generated by the fuel cell,
wherein the fuel cell, the auxiliary device and the converter are arranged serially in a front-back direction of the vehicle and the auxiliary device is arranged so as to be adjacent to the fuel cell,
wherein the fuel cell is formed by stacking a predetermined number of unit cells, each unit cell being supplied with the oxidant gas and the fuel gas and generating electric power through the electrochemical reaction, and the oxidant gas is supplied and discharged at one end of the fuel cell in the cell stacking direction and the fuel gas is supplied and discharged at the other end of the fuel cell in the cell stacking direction, and
wherein the converter, the fuel cell and the auxiliary device are serially arranged in this order from the front in the front-back direction of the vehicle.

8. The vehicle fuel cell system according to claim 6, wherein the auxiliary device includes: a device related to supply and discharge of fluid to and from the fuel cell; and a pipe and/or wiring connected to the device.

9. The vehicle fuel cell system according to claim 7, wherein the auxiliary device includes: a device related to supply and discharge of fluid to and from the fuel cell; and a pipe and/or wiring connected to the device.

10. A fuel cell vehicle having the vehicle fuel cell system according to claim 6 mounted therein,
wherein: a controller that controls the converter, the auxiliary device and the fuel cell; a radiator for cooling the fuel cell and the converter; a traction motor for driving the vehicle, which is electrically connected to the converter; and an air compressor that compresses air, as the oxidant gas, and sends the air to the fuel cell, are arranged in a compartment formed at the front of the vehicle, and
wherein the converter, the auxiliary device and the fuel cell are arranged at the back of the compartment, in an underfloor space formed under an interior of the vehicle.

11. A fuel cell vehicle having the vehicle fuel cell system according to claim 7 mounted therein,
wherein: a controller that controls the converter, the auxiliary device and the fuel cell; a radiator for cooling the fuel cell and the converter; a traction motor for driving the vehicle, which is electrically connected to the converter; and an air compressor that compresses air, as the oxidant gas, and sends the air to the fuel cell, are arranged in a compartment formed at the front of the vehicle, and
wherein the converter, the auxiliary device and the fuel cell are arranged at the back of the compartment, in an underfloor space formed under an interior of the vehicle.
